(19) United States
(12) Patent Application Publication
(10) Pub. No.: US 2010/0256277 A1
(43) Pub. Date: Oct. 7, 2010

(54) NON-AROMATIC HYDROCARBON ADHESIVE AND METHOD OF FABRICATION

(76) Inventor: HUNG-CHE LEE, Taipei City (TW)

Correspondence Address: LEONG C LEI, PMB # 1008, 1867 YGNACIO VALLEY ROAD, WALNUT CREEK, CA, 94598, US

(21) Appl. No.: 12/418,617

(22) Filed: Apr. 6, 2009

(51) Int. Cl. C09J 107/00

(52) U.S. Cl. 524/315

(57) ABSTRACT

Adhesive contains no benzene, toluene, or xylene and the method of fabrication is disclosed. 50% MCH, 30% NPAC and 20% MEK are mixed to dissolve. In sequence, natural rubber, monomers are mixed and heated to dissolve. At about 75-80° C., thermal initiator starts thermal polymerization reaction, and it stops by adding a terminal agent. The reaction temperature is cooled to 60° C. and a promoter is added to obtain a treating agent. Next, the treating agent, MCH and NPAC are mixed, and is added with natural rubber, and NPAC is added gradually. The obtained adhesive contains no benzene, toluene, or xylene.

### TECHNICAL FIELD OF THE INVENTION

The present invention relates to non-aromatic hydrocarbon adhesive which contains no benzene, toluene, or xylene, and also relates to method of fabrication.

### DESCRIPTION OF THE PRIOR ART

Industrial adhesives such as super adhesive or binding adhesive that available in market require the mixing of aromatic solvents, such as benzene, toluene or xylene. These solvents produce poisonous odor which causes toxication to skin, eyes or respiratory system. The poisonous odor will cause inflammation to sensitive skin, throat swollen, bronchitis and blood platelets reduction. Long term inhaling of aromatic vapor will cause leukemia, an increase in white blood cell, and or abnormal menstruation.

If the poisonous odor of these aromatic hydrocarbons are in contact at pregnancy, it will cause abnormal to fetus and retardation of growth of fetus. aromatic hydrocarbons are considered by WHO as a carcinogen material.

Recently, the application of aromatic solvents containing benzene, toluene or xylene is greatly reduced so as to reduce toxication of aromatic hydrocarbon. For instance, in shoes manufacturers, industrial adhesive that used for shoe manufacturing is strictly observed not to contain toxic aromatic hydrocarbons. This will ensure the safety of operators in shoes manufacturing factories and the safety of use for the consumers.

In view of drawbacks of the industrial adhesive with no aromatic hydrocarbons, which is found that the stickiness is poor, the inventor of the present invention makes use of methylcyclohexane (MCH), n-propyl acetate (NPAC) and methylethylketone (MEK) to fabricate adhesive containing no aromatic hydrocarbons. In addition, the stickiness of the industrial adhesive is excellent.

### SUMMARY OF THE INVENTION

Accordingly, it is an object of the present invention to provide a method for the manufacturing of a non-aromatic hydrocarbon adhesive comprising the steps of a first mixed dissolution, a second mixed dissolution, a first thermal polymerization, a second thermal polymerization, end of the polymerization reaction, and a mixed adhesive fabrication process.

In the first mixed dissolution, natural rubber is dissolved with MCH, NPAC and MEK; and in the second mixed dissolution, the raw material of step (i) is heated to a temperature of 70° C. and together with adding monomers.

In at least one thermal polymerization reaction so as to increase the said raw material to 75-80° C., heat initiator is added to set the time of thermal polymerization reaction.

In the terminal polymerization reaction, the raw material after thermal polymerization is added with a terminal agent so as to stop the thermal polymerization reaction, and the raw material is cooled to 60° C. until all the thermal polymerization reaction stops, then a sulfur promoter is added so as to complete the preparation of a treating agent.

In the mixed adhesive fabrication process, the liquid state treating agent and MCH, and NPAC are added to fabrication equipments and then mixed with solid natural rubber, wherein in the mixing process, NPAC is gradually added until a non-aromatic hydrocarbon adhesive is obtained.

Yet still another object of the present invention is to provide a non-aromatic hydrocarbon adhesive comprises 60-70% of NPAC; 25-35% of MCH; 5-15% of MEK; and natural rubber.

Other objects, and advantages will become more apparent in view of the following detailed description in conjunction with the accompanying drawings.

### BRIEF DESCRIPTION OF THE DRAWINGS

FIG. 1 shows the flowchart of a preferred embodiment of the present invention.

FIG. 2 shows the components ratio of the mixed solution of the preferred embodiment of the present invention.

FIG. 3 shows the component ratio of the non-aromatic hydrocarbon adhesive obtained in accordance with a preferred embodiment of the present invention.

### DETAILED DESCRIPTION OF THE PREFERRED EMBODIMENTS

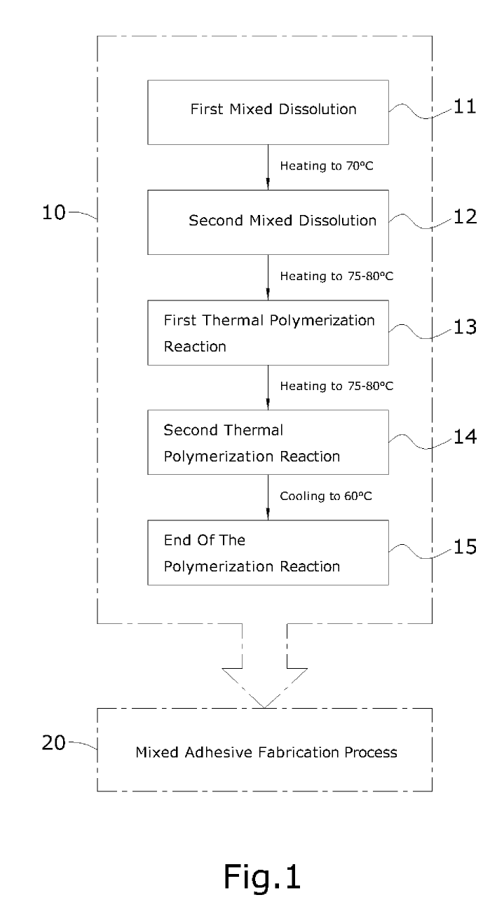

Referring to FIG. 1, there is shown a preferred embodiment in accordance with the present invention. The fabrication process in accordance with the present invention includes the manufacturing of treating agent and the manufacturing of the mixed adhesive. Two stages are used in the present invention.

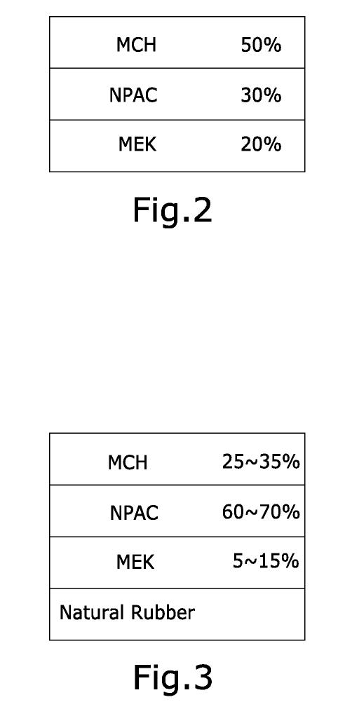

The first stage is related to the fabrication of treating agent 10, i.e., thermal polymerization reaction. The method includes
(i) A first mixed dissolution 11. Natural rubber such as smoked rubber is placed in a mixed solution (as shown in FIG. 2, which contains 50% MCH, 30% NPAC and 20% MEK) to proceed with mixing dissolution;
(ii) A second mixed dissolution 12. The raw material obtained in the first step is heated to 70° C. After that, MMA and NBMA monomers are added to proceed with the dissolution.

In the first thermal polymerization reaction 13, the above said raw material are heated to 75-80° C., and are then added with benzophenone heat initiator for thermal polymerization reaction for 4 hours.

At the second thermal polymerization reaction 14, after 4 hours of thermal polymerization reaction, the temperature is maintained at 75 to 80° C. Appropriate amount of heat initiator is added, and the thermal polymerization reaction continues for about 4 hours. In accordance with inventor's experiments, second time thermal polymerization reaction is the best.

End of the polymerization reaction 15. The raw material, after two time thermal polymerization react, thermal polymerization reaction continues as the temperature gradually decreases. Thus, terminal agent has to be added to terminate the thermal polymerization reaction; and maintain the reaction at 60° C. until all thermal polymerization reaction is stopped. Finally, sulfur promoter is added to obtain the treating agent.

In a mixed adhesive fabrication process 20, the treating agent, MCH and NPAC are added to the fabrication devices to proceed with the mixing. After that, solid state natural rubber is added. In the mixing process, NPAC is added gradually. It should be aware that MCH and NPAC cannot be added at once. They could be added gradually. Adhesive with no benzene, toluene or xylene is obtained.

As shown in FIG. 3, in the two stages of fabrication of the present invention, the mixed solution were used in the first stage contains 50% MCH, 30% NPAC and 20% MEK. At this second stage, MCH and NPAC and natural rubber are gradually added. Thus, the non-aromatic hydrocarbon adhesive contains essentially about 60-70% of NPAC, about 25-35% MCH and 5-15% MEK and natural rubber.

In view of the above, MCH used in the present method is obtained from hydrogenation, and as a result, the content of toluene is not zero. However, as a whole, the contents of benzene, toluene and xylene are within a standard safety level. The use of natural rubber increases the safety of the adhesive and the stickiness of the adhesive.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for the manufacturing of a non-aromatic hydrocarbon adhesive comprising the steps of
(i) a first mixed dissolution by dissolving natural rubber with MCH, NPAC and MEK;
(ii) a second mixed dissolution by heating the raw material of step (i) to a temperature of 70° C. and together with adding monomers;
(iii) at least one thermal polymerization reaction so as to increase the said raw material to 75-80° C., wherein heat initiator is added to set thermal polymerization reaction;
(iv) end of the polymerization reaction, wherein the raw material after thermal polymerization is added with a terminal agent so as to stop the thermal polymerization reaction, cooling the raw material to 60° C. until all the thermal polymerization stops, adding sulfur promoter so as to complete a treating agent; and
(v) a mixed adhesive fabrication process by mixing the liquid state treating agent and MCH, NPAC in a fabrication equipments and then mixed with solid natural rubber, wherein in the mixing process, NPAC is gradually added until a non-aromatic hydrocarbon adhesive is obtained.

2. The method of claim 1, wherein the thermal polymerization reaction is operated twice under the same temperature.

3. The method of claim 1, wherein the natural rubber is smoked rubber.

4. The method of claim 1, wherein the monomers are MMA and NBMA.

5. The method of claim 1, wherein the heat initiator is benzophenone (BPO).

6. The method of claim 1, wherein the treating agent comprises 50% MCH, 30% NPAC and 20% MEK.

7. The method of claim 1, wherein in the mixed adhesive process natural rubber and smoked rubber are mixed composition.

8. A non-aromatic hydrocarbon adhesive comprises
60-70% of NPAC;
25-35% of MCH;
5-15% of MEK; and
natural rubber.
